(19) United States
(12) Patent Application Publication
(10) Pub. No.: US 2026/0322064 A1
(43) Pub. Date: Oct. 15, 2026

(54) PASSIVELY Q-SWITCHED LASER

(71) Applicant: JERUSALEM COLLEGE OF TECHNOLOGY, Jerusalem (IL)

(72) Inventor: Noach SALMAN, Jerusalem (IL)

(21) Appl. No.: 19/467,262

(22) Filed: Feb. 2, 2026

Related U.S. Application Data
(60) Provisional application No. 63/752,783, filed on Feb. 2, 2025.

(51) Int. Cl. H01S 3/113; H01S 3/102; H01S 3/137; H01S 3/16

(52) U.S. Cl. CPC H01S 3/113; H01S 3/1024; H01S 3/137; H01S 3/1616; H01S 3/1653

(57) ABSTRACT

A passively Q-switched laser (“PQSL”) and a method for its use are hereby disclosed. The PQSL comprises a laser gain medium having an output wavelength of approximately 2 μm, a saturable absorber (“SA”) characterized by an absorption spectrum that includes at least one narrow and pronounced absorption peak at the emission wavelength of the laser gain medium, and a wavelength stabilization element (“WSE”) configured to transmit a wavelength corresponding to a peak absorption of the SA. The WSE thereby stabilizes the laser output at a wavelength corresponding to the peak absorption of the SA and is positioned within the optical path defined by the entrance mirror and the output coupler. In preferred embodiments, the laser gain medium comprises a pumped Tm:YLF gain medium, Q-switched by a Ho:YAG saturable absorber and stabilized by a wavelength stabilization element selected from one or more etalons.

### CROSS REFERENCE TO RELATED APPLICATION

This Application Claims the Benefit of Priority of U.S. Provisional Patent Application No. 63/752,783, filed on Feb. 2, 2025, the contents of which are all incorporated herein by reference in their entirety.

### FIELD OF THE INVENTION

The present invention generally relates to passively Q-switched lasers (“PQSL”) and methods for generating laser light pulses therefrom, and more particularly to a PQSL comprising means for enhancing power output and wavelength stability, as well as associated methods.

### BACKGROUND OF THE INVENTION

Laser systems emitting in the two-micrometer (2 μm) region have a wide array of applications, including but not limited to gas spectroscopy, medical surgery, material processing, LIDAR, and as pump sources for mid-infrared (mid-IR) lasers [1]. For many such applications, high-energy, short-pulsed laser sources are advantageous, and in some cases, essential. The predominant technique for generating such pulses is Q-switching, which may be implemented using either active elements, such as acousto-optic and electro-optic modulators, or passive elements, such as saturable absorbers (“SA”).

Passive Q-switching utilizing SAs provides advantages in terms of compactness, operational convenience, and cost-effectiveness relative to active Q-switching. However, the pulse energy achievable by passively Q-switched lasers is inherently constrained by their design, and scaling to higher energies presents significant challenges. Currently, Cr:ZnS and Cr:ZnSe crystals are the principal materials employed to achieve high-energy pulses in passively Q-switched lasers operating in the 2-μm region [3,4,5]. These crystals exhibit a broad and pronounced absorption peak at 1.65 μm, with substantial absorption extending beyond 2 μm.

Recent investigations employing these crystals have demonstrated pulse energies of several millijoules. Notwithstanding their efficacy, these crystals are both costly and scarce, and their limited damage threshold can restrict the achievable pulse energy density, thereby constraining designs intended for high pulse energies. As an alternative, Ho-doped crystals have been proposed for use as saturable absorbers in thulium lasers; see, for example, US20110158267, which employs thulium as a saturable absorber, but not holmium (Ho). Ho-doped crystals exhibit high absorption peaks within the emission wavelength range of Tm lasers; see, for example, WO2015057285. The principal advantages of Ho-doped crystals include a higher damage threshold compared to Cr:ZnS/Cr:ZnSe, as well as their technological and commercial maturity as gain media.

Nevertheless, the implementation of Ho-doped crystals as SAs for thulium lasers is subject to two principal challenges. First, the spectral profile of the Ho absorption cross-section is characterized by sharp peaks, only a few nanometers wide, wherein the width refers to a value close to the peak (approximately 90% of maximum), rather than the more commonly measured half-maximum. The introduction of a Ho-doped crystal into the laser resonator induces a shift in the lasing wavelength to a region where the absorption is relatively low, i.e., outside these sharp peaks.

This results in a low absorption cross-section at the lasing wavelength, which in turn leads to slow saturation and low energy pulses, and may even preclude the laser from reaching the second threshold.

The second challenge pertains to the long upper-state lifetime of Ho-doped crystals, typically on the order of several milliseconds. This extended lifetime causes the transmission of the SA, following saturation, to decay more slowly than the rate at which the population inversion in the gain medium increases. As a result, less energy is stored for subsequent pulses, causing the laser to stabilize at a reduced pulse energy after the initial high-energy pulse. Prior studies utilizing Ho-doped crystals as SAs for thulium lasers have reported substantially lower performance compared to Cr:ZnS/Cr:ZnSe crystals. For example, a study employing Ho:LuAG ceramic as an SA for a Tm:Y₂O₃ ceramic laser reported a pulse energy of 15 μJ, a pulse width of 642 ns, and an efficiency of 2.5%. Another study, utilizing flash lamp pumping, achieved a pulse energy of 11 mJ, a pulse width of 45 ns, and an efficiency of 0.0137%. In these studies, the gain and SA host crystals were selected such that the lasing wavelength corresponded to a relatively flat absorption region of the Ho-doped crystals, characterized by a lower absorption cross-section than the narrow absorption peaks. This constraint also limited the available design options for the gain and SA host media.

Various methods have been employed to enhance the efficiency and pulse energy of passively Q-switched lasers, such as optimizing the position of the saturable absorber within the laser cavity; see, for example, Chinese Patent Application No. 109167242. In prior studies involving Ho-doped crystals as SAs, the lasing wavelength was situated in a region of weak and uniform absorption, as described in [6,7].

However, to achieve a very short, narrow, high-energy pulse, it is necessary to force the emission wavelength of the laser to coincide with an absorption peak of the Ho-doped crystal [2]. Furthermore, to obtain a single, distinct emission band, secondary pulses must be suppressed. Additionally, to maximize the energy stored for subsequent pulses, the long-lived upper state of the SA between pulses should be allowed to deplete.

Accordingly, there remains a long-felt and unmet need for means and methods to optimize the output of a Q-switched laser in which the SA is characterized by broad absorption with sharp peaks within the wavelength region of the gain medium's output.

### SUMMARY OF THE INVENTION

It is an object of the present invention to provide a passively Q-switched laser system comprising: an entrance mirror; an output coupler; a gain medium disposed between the entrance mirror and the output coupler; a saturable absorber (“SA”), characterized by an absorption spectrum containing at least one absorption peak at an emission wavelength of the gain medium, disposed such that light emitted by the gain medium impinges upon the SA; and an optical pump configured to emit light corresponding to at least one absorption spectral line of the gain medium and focusable to illuminate the gain medium; wherein the system further comprises at least one wavelength stabilizing element. The wavelength range is determined relative to the absorption peak wavelength of the saturable absorber crystal. Optionally, the absorption peak of the saturable absorber is about 10 nm [full width at 90% maximum (FW(90%)M)].

It is a further object of the invention to provide, in a passively Q-switched laser system comprising an entrance mirror; an output coupler; a gain medium disposed between the entrance mirror and the output coupler; a saturable absorber (“SA”), characterized by an absorption spectrum containing at least one absorption peak at an emission wavelength of the gain medium, disposed such that light emitted by the gain medium impinges upon the SA; and an optical pump configured to emit light corresponding to at least one absorption spectral line of the gain medium and focusable to illuminate the gain medium, at least one wavelength stabilizing element (“WSE”) configured to restrict the intra-cavity light to a wavelength within the defined range.

It is a further object of the invention to provide the system as defined above, wherein the WSE is selected from the group consisting of a Volume Bragg Grating (“VBG”), an etalon, or a combination of at least one VBG and at least one etalon.

It is a further object of the invention to provide the system as defined in any of the foregoing, wherein the output coupler comprises a VBG.

It is a further object of the invention to provide the system as defined in any of the foregoing, wherein the output coupler is characterized by a reflectance of 60% at the absorption peak of SA.

It is a further object of the invention to provide the system as defined in any of the foregoing, wherein the WSE comprises a 5 mm intra-cavity etalon.

It is a further object of the invention to provide the system as defined in any of the foregoing, wherein the WSE comprises a series of three etalons in the range of 10 to 100 μm.

It is a further object of the invention to provide the system as defined in any of the foregoing, wherein the gain medium comprises a Tm-doped crystal.

It is a further object of the invention to provide the system as defined in any of the foregoing, wherein the gain medium comprises Tm:YLF.

It is a further object of the invention to provide the system as defined in any of the foregoing, wherein the SA comprises a Ho-doped crystal.

It is a further object of the invention to provide the system as defined in any of the foregoing, wherein the SA comprises Ho:YAG.

It is a further object of the invention to provide the system as defined in any of the foregoing, wherein the gain medium is Tm:YLF and the SA is Ho:YAG.

It is a further object of the invention to provide the system as defined in any of the foregoing, wherein the PQSL is configured to emit light at a wavelength selected from the group consisting of 1,880±2 nm and 1,907±2 nm.

It is a further object of the invention to provide the system as defined in any of the foregoing, wherein the optical pump is modulated to cease pumping after a pulse of the gain medium and to resume only after depletion of the upper energy state of the SA.

It is a further object of the invention to provide the system as defined in any of the foregoing, wherein the optical pump modulation is in the range of 10 to 500 Hz.

It is a further object of the invention to provide the system as defined in any of the foregoing, wherein the system is configured to produce a pulse duration of 33 to 58 ns.

It is a further object of the invention to provide the system as defined in any of the foregoing, wherein the laser optical path is configured to be folded by a folding mirror (250).

It is a further object of the invention to provide the system as defined in any of the foregoing, wherein the angle of incidence of the folding mirror is 15°.

It is a further object of the invention to provide a method for generating laser light pulses in a PQSL, the method comprising the steps of: providing a laser with an entrance mirror and an output coupler that together define an optical path; introducing a focusable optical pump external to the entrance mirror and aligned with the optical path; introducing a saturable absorber (SA) into the laser optical path, the SA characterized by an absorption spectrum containing at least one absorption peak at an emission wavelength of the gain medium; and inserting into the laser's optical path a WSE configured to transmit light at a wavelength corresponding to an absorption peak of the SA and at a wavelength emitted by the gain medium.

It is a further object of the invention to provide the method as defined in any of the foregoing, wherein at least one additional WSE is introduced into the laser optical path to suppress secondary emissions.

It is a further object of the invention to provide the method as defined in any of the foregoing, wherein the WSE is selected from the group consisting of a Volume Bragg Grating (VBG), an etalon, or a combination of at least one VBG and at least one etalon.

It is a further object of the invention to provide the method as defined in any of the foregoing, wherein the output coupler is provided with a VBG.

It is a further object of the invention to provide the method as defined in any of the foregoing, wherein the output coupler is provided with a reflectance of 60% at the absorption peak of the SA and comprises a VBG.

It is a further object of the invention to provide the method as defined in any of the foregoing, wherein the WSE is provided with a 5 mm intra-cavity etalon.

It is a further object of the invention to provide the method as defined in any of the foregoing, wherein the WSE is provided with a train of three etalons in the range of 10 to 100 μm.

It is a further object of the invention to provide the method as defined in any of the foregoing, wherein the gain medium is provided with a Tm-doped crystal.

It is a further object of the invention to provide the method as defined in any of the foregoing, wherein the gain medium is provided with Tm:YLF.

It is a further object of the invention to provide the method as defined in any of the foregoing, wherein the SA is provided with a Ho-doped crystal.

It is a further object of the invention to provide the method as defined in any of the foregoing, wherein the SA is provided with Ho:YAG.

It is a further object of the invention to provide the method as defined in any of the foregoing, wherein the gain medium is provided with Tm:YLF, and the SA is provided with Ho:YAG.

It is a further object of the invention to provide the method as defined in any of the foregoing, wherein the system is configured to emit light at a wavelength selected from the group consisting of 1,880±2 nm and 1,907±2 nm.

It is a further object of the invention to provide the method as defined in any of the foregoing, wherein the optical pump is modulated to cease pumping after a pulse of the gain medium and is resumed only after depletion of the upper energy state of the SA.

It is a further object of the invention to provide the method as defined in any of the foregoing, wherein the optical pump is modulated within a range of 10 to 500 Hz.

It is a further object of the invention to provide the method as defined in any of the foregoing, wherein the system is configured to produce a pulse duration of 33 to 58 ns.

It is an object of the invention to disclose the method as defined in any of the above, wherein

It is a further object of the invention to provide the method as defined in any of the foregoing, wherein the angle of incidence of the folding mirror is 15°.

### BRIEF DESCRIPTION OF THE DRAWINGS

The invention will be more readily understood from the following detailed description, which should be read in conjunction with the accompanying drawings, wherein reference numerals refer to like structural elements throughout, and in which:

FIG. 1 is a schematic diagram depicting a passively Q-switched laser system incorporating a wavelength stabilization element, in accordance with a non-limiting embodiment of the invention as disclosed herein;

FIGS. 2a-2b are schematic diagrams illustrating a second non-limiting embodiment of the invention as disclosed herein;

FIG. 3 is a schematic diagram illustrating a third non-limiting embodiment of the invention as disclosed herein;

FIG. 4 is a prior art reference spectrum depicting the Ho:YAG absorption cross-section;

FIGS. 5a and 5b illustrate output wavelength profiles of a Tm:YLF laser without and with a wavelength stabilization element (WSE) in the laser optical path, respectively; and,

FIG. 6 illustrates the relationship between pumping duration and repetition rate in accordance with one embodiment of the invention as disclosed herein;

FIG. 7 is a graph depicting the pulse energy and efficiency as a function of repetition rate for a non-limiting embodiment of the invention as disclosed herein;

FIGS. 8A and 8B depict the time-dependent output intensity for a 50 Hz pulse train and a single 33-ns pulse, respectively, produced by a laser constructed in accordance with a non-limiting embodiment of the invention as disclosed herein; and,

FIG. 9 is a graph illustrating the beam quality of the output of a laser constructed according to one embodiment of the invention disclosed herein, with beam factor quality measured to be M²<1.1.

### DETAILED DESCRIPTION OF THE PREFERRED EMBODIMENTS

In the following description, various aspects of the invention are set forth. For purposes of explanation, specific details are provided to facilitate a thorough understanding of the invention. It will be apparent to those skilled in the art that alternative embodiments may be implemented without departing from the essential nature of the invention. Accordingly, the invention is not limited to the specific embodiments illustrated in the figures or described in the specification, but is defined solely by the appended claims, which are to be interpreted in accordance with the broadest reasonable construction. For clarity or conciseness, individual elements of the invention may be discussed separately; however, any non-contradictory combination of such elements is deemed by the inventors to be within the scope of the invention.

As used herein, unless expressly defined otherwise, the term “about,” when referring to numerical quantities, denotes a range of ±25% relative to the nominal value.

Unless expressly stated otherwise, any range disclosed herein shall be deemed to encompass all subranges subsumed therein. By way of non-limiting example, if a range is stated as “1 to 10%,” then ranges such as 1 to 5%, 2 to 9%, and the like, are included within the scope of the invention; similarly, if a range is stated as “less than 50%,” then ranges such as less than 40%, less than 25%, less than 10%, and so forth, are included within the scope of the invention.

The term “Brewster window,” as used herein in a non-limiting manner, refers to an optical component commonly employed in laser systems to minimize reflection losses. It comprises a transparent plate, typically fabricated from glass or another suitable material, positioned at Brewster's angle, thereby permitting p-polarized light (i.e., light polarized with its electric field in the plane of incidence) to traverse the window with minimal reflection.

As used herein, with respect to a pulse or peak shape, the terms “pulse width” or “peak width” refer to the full width at half maximum (FWHM) value of the peak.

As used herein, the term “etalon” refers to an optical device employed to measure narrow-frequency bandwidths, comprising two parallel reflecting surfaces. The term also encompasses an interferometer; wherein light waves are transmitted or reflected at specific frequency as a function of the thickness and refractive index of the material disposed between the surfaces.

As used herein, the term “FWHM” denotes the “Full Width at Half Maximum” of a spectral peak.

As used herein, the term “PQSL” refers to a “Passively Q-switched Laser.”

As used herein, the term “WSE” refers to a “wavelength stabilization element.”

As used herein, the term “SA” refers to a “saturable absorber.”

As used herein, the term “VBG” refers to a “Volume Bragg Grating.”

In another embodiment of the invention, the system as defined herein may include pump optics that are integrated with, or otherwise associated with, the system and/or its modules. An optional focusing optic may be employed in connection with the pump. An optional pump source may be provided, which may be integrated with the optics and may not require additional external optics.

In accordance with one embodiment of the invention, a passively Q-switched laser system is disclosed. The system comprises, inter alia, an entrance mirror, an output coupler, and a gain medium disposed therebetween. The system further includes a saturable absorber (SA) having an absorption spectrum with at least one peak at the emission wavelength of the gain medium, the SA being positioned to intercept light emitted from the gain medium. Additionally, the system employs an optical pump configured to generate light corresponding to at least one absorption spectral line of the gain medium, which may be focused on efficiently illuminating the gain medium. Furthermore, the system comprises at least one wavelength stabilization element (WSE) that restricts the light within the cavity to a specific wavelength range as defined herein.

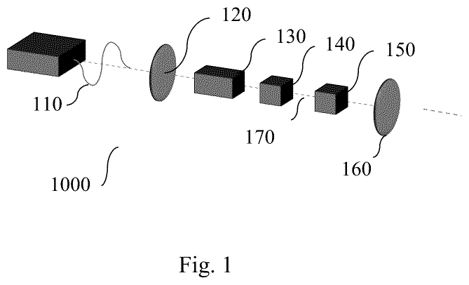

Reference is now made to FIG. 1, which depicts a schematic diagram of a non-limiting embodiment 1000 of an improved passively Q-switched laser (PQSL) comprising a WSE. PQSL 1000 includes an ex-cavity optical pump 110 disposed along the optical path, an entrance mirror 120, and an output coupler 160. The output coupler may be any type known in the art suitable for use at the laser output wavelength. The system further comprises a gain medium 130, a SA 140 positioned between the entrance mirror and the output coupler, and a wavelength stabilization element 150 disposed within the optical path. Upon optical pumping of the gain medium, a pulsed output laser beam 170—which term is used interchangeably herein with “optical path” is produced as described in further detail below.

As described in further detail below, the WSE is a device that transmits light within a limited wavelength range and may be of any type known in the art. Non limiting examples include one or more etalons, one or more VBGs, or any combination thereof. In typical embodiments, the WSE possesses a bandwidth as defined herein, for example, approximately 1 nm.

In certain preferred embodiments, the laser pump is focused within the gain medium by means of a lens pair.

In certain preferred embodiments, the pump is modulated at low frequencies in the range of 10 to 500 Hz.

In certain preferred embodiments, the pump source is modulated up to 100 Hz to facilitate recovery of the SA transmittance.

In some preferred environments of the invention, the gain medium is a water-cooled Tm-doped crystal.

In certain preferred embodiments, the SA is a Ho-doped crystal.

In certain preferred embodiments, the SA is positioned in close proximity to the laser gain medium to minimize the area ratio, thereby promoting more rapid SA saturation.

In some preferred embodiments of the invention, the WSE is a VBG which is incorporated into the output coupler.

In certain preferred embodiments, an additional WSE is provided in the form of a 5 mm etalon, which serves to further stabilize the wavelength of light within the laser cavity and to suppress secondary emissions.

In one preferred embodiment, a Ho:YAG crystal is employed as a SA for a Tm:YLF laser. Narrowband, millijoule-level pulse energy is achieved through the use of an etalon and a VBG as the output coupler.

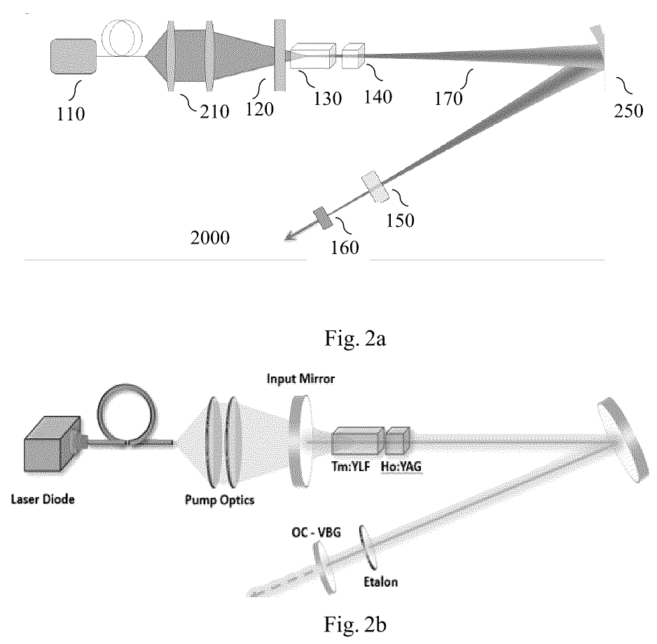

Reference is now made to FIGS. 2a-2b, which illustrate schematic diagrams of a second non-limiting embodiment 2000 of an improved PQSL comprising a WSE. PQSL 2000 includes an optical pump 110 and a folded laser cavity formed between an entrance mirror 120, an output coupler 160, and a folding mirror 250, with an angle of incidence θ, which in typical embodiments is approximately 15°. Disposed along the optical path of the laser beam and subsequent to the entrance mirror 120 are a gain medium 130, a SA 140, and a WSE 150. A WSE is positioned before the output coupler 160, which also serves as a VBG. The laser pump 110 is focused by pump optics 210 onto the gain medium. Upon optical pumping of the gain medium, a pulsed output laser beam 170 is produced as described in further detail below.

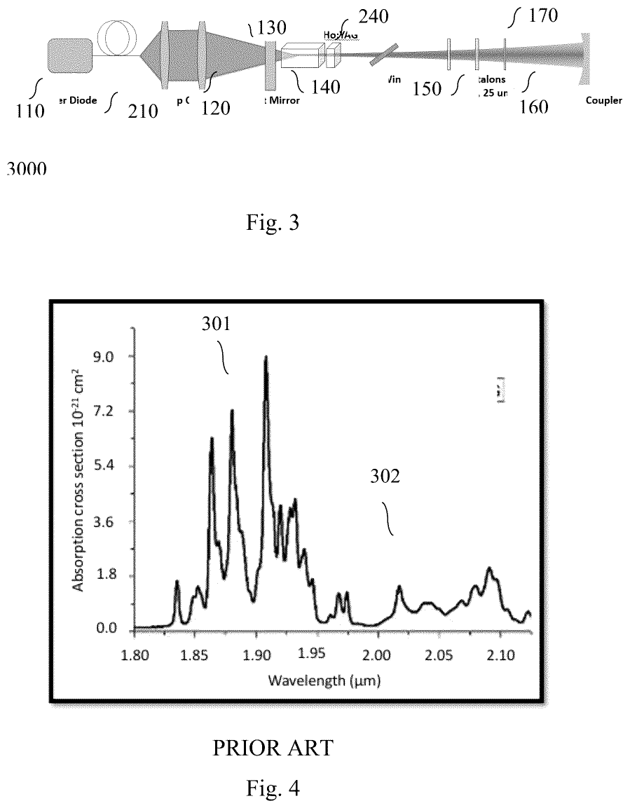

Reference is now made to FIG. 3, which depicts a schematic diagram of another non-limiting embodiment 3000 of an improved PQSL comprising a WSE. PQSL 3000 includes a pump 110 and a laser cavity formed between an entrance mirror 120 and an output coupler 160. Disposed along the optical path of the laser beam and following the entrance mirror 120 are a gain medium 130, a SA 140, Brewster windows 240, and a WSE 150 comprising three etalons of typical width in the range of 10-100 μm, arranged sequentially. The WSE 150 is positioned before the output coupler 160. The laser pump 110 is focused by pump optics 210 onto the gain medium. Upon optical pumping of the gain medium, a pulsed output laser beam 170 is produced as described in further detail below.

The disclosed system provides a novel method for employing Ho-doped crystals as SAs, utilizing an element in the laser optical path to constrain the wavelength to the Ho-doped crystal absorption peak, thereby preventing wavelength drift and enabling the generation of energetic pulses using SA crystals with specific absorption characteristics.

Reference is now made to FIG. 4, which presents an absorption spectrum in the 1.8-2.1 μm region of a Ho:YAG crystal [2]. As is characteristic of Ho-doped crystals, the spectrum includes a region at relatively short wavelengths 301 exhibiting narrow and strong absorption peaks, and a region at longer wavelengths 302 where the absorption is broader and more uniform, but significantly weaker by comparison.

The invention disclosed herein encompasses a novel system and method for stabilizing the laser output at a wavelength corresponding to a peak absorption of the SA. A WSE, tuned to transmit a wavelength corresponding to a peak absorption of the SA, is inserted into the optical path defined by the entrance mirror and output coupler.

The following examples are provided to enable a person of ordinary skill in the art to make and use the invention disclosed herein and are not intended to be limiting in any respect.

### Example 1

Presented herein is an example of the embodiment illustrated in FIG. 2, comprising a passively Q-switched Tm:YLF solid-state laser operating at 1879.3 nm and utilizing Ho:YAG as a saturable absorber.

A VBG, tuned to the absorption peak of the Ho-doped crystal (1879.3 nm), was employed as an output coupler. Pulse energies up to 2.7 mJ at repetition rates up to 100 Hz were achieved. Ho-doped crystals may serve as saturable absorbers for thulium lasers, demonstrating their potential for high-energy pulse production in the 2-μm range.

This was accomplished by incorporating a volume Bragg grating (VBG) into the laser cavity. A Ho:YAG crystal was utilized as a SA for a Tm:YLF laser. Narrowband, millijoule-level pulse energy was achieved using a 5 mm intra-cavity etalon and an output coupler comprising a VBG with 60% reflectance at 1879.3 nm.

The system 2000, as illustrated in FIGS. 2a-b, comprises a folded laser with a total length of 207 mm. The cavity was formed between a plane input mirror 120 and a plane VBG serving as an output coupler with 60% partial reflectance at 1879.3 nm 160. A folding mirror with a 200 mm radius of curvature 250 was used at a 15° angle of incidence. The gain medium 130 was a 3×3×10 mm³ Tm:YLF crystal (3 at. % doping), water-cooled to 20 °C. A 3×3×2.5 mm³ Ho:YAG crystal (1 at. % doping) served as the SA 140, positioned as close as possible, e.g., about 2 mm, (e.g., by means of a distancer) to the laser crystal to minimize the area ratio for faster SA saturation. A 5 mm etalon 150 was placed before the output coupler for spectral narrowing. The system was end-pumped by a 793 nm laser diode 110 operating at 16 W, focused 210 to 300 μm inside the crystal using a lens pair. Measurements were conducted using an energy meter (Ophir, PE50-DIF-ER-C) for pulse energy, a 12.5 GHz extended InGaAs photodetector (EOT, ET-5000) with an oscilloscope (Agilent, DSO-X 2012A) for temporal characterization, and a spectrometer (Bristol spectrum analyzer 772) for spectral analysis.

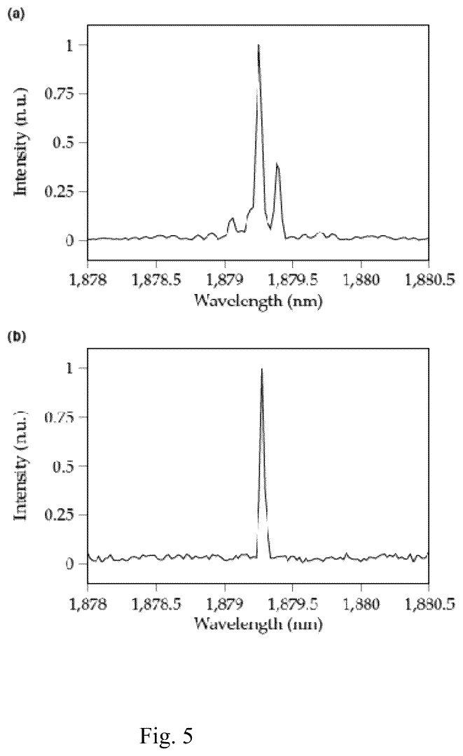

Reference is now made to FIGS. 5a and 5b, which demonstrate the effect of introducing a 5 mm etalon as a WSE into the optical path of a Tm:YLF PQSL. In the initial configuration, the etalon was absent, and the laser emission spectrum exhibited three distinct narrow bands, as shown in FIG. 5a, each separated by approximately 200 pm. Secondary pulses were also observed, with time intervals ranging from partial overlap to 200 ns. Upon insertion of the 5 mm etalon into the laser cavity, the spectral output was reduced to a single distinct band and secondary pulses were eliminated, as illustrated in FIG. 5b.

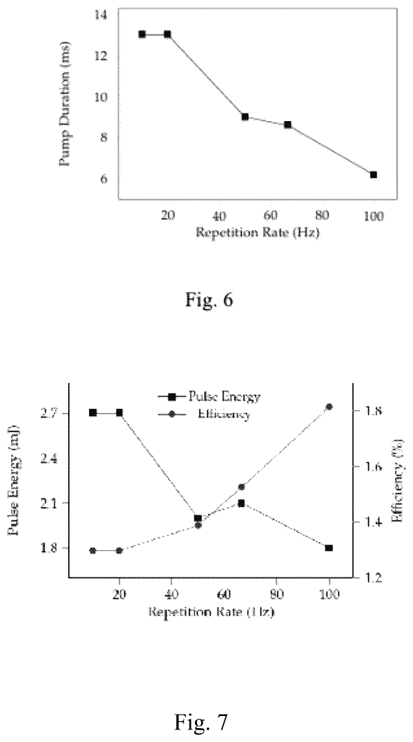

Reference is now made to FIG. 6, which illustrates the role of pump control. Under continuous pumping, the laser stabilized at a pulse energy of approximately 200 μJ and a repetition rate of several kHz, attributable to the long upper-state lifetime of Ho:YAG, resulting in stabilization at high transmission. To achieve higher pulse energies, pump modulation at low repetition rates (10-100 Hz) was implemented, permitting depletion of the SA's long-lifetime upper state between pulses. The pump duration was optimized at each frequency to produce a single pulse.

Reference is now made to FIG. 7, which demonstrates the effect of laser repetition rate on pulse energy. The modulated pump configuration yielded a maximum pulse energy of 2.7 mJ at low repetition rates. Pulse energy was found to be dependent on the laser repetition frequency. At low repetition rates, the inter-pulse interval significantly exceeded the upper-state lifetime, allowing for near-complete depletion of the SA's upper-state population. This resulted in lower initial transmission and, consequently, higher pulse energies. In contrast, at 100 Hz, the inter-pulse interval (1.17 times the upper-state lifetime) resulted in only 69% depletion of the SA's upper-state population, leading to higher initial transmission and lower pulse energies. However, while increasing the repetition rate leads to a reduction in pulse energy, the laser efficiency improves. This improvement in efficiency at higher repetition rates is due to the reduced time between pulses, which limits the depletion of the residual population inversion in the Tm:YLF gain medium through spontaneous emission. Consequently, higher repetition rates enhanced lasing efficiency due to improved energy retention in the gain medium. FIG. 7 illustrates this trade-off, showing increased efficiency and decreased pulse energy as the repetition rate increases. The pulse duration ranged from 33 to 58 ns, with higher pulse energies corresponding to shorter pulse durations.

Optionally, and according to an embodiment of the invention, beam quality is described by the parameter M2 (proportional to the waist radius multiplied by the divergence angle). ω(z) is the beam radius at position z.

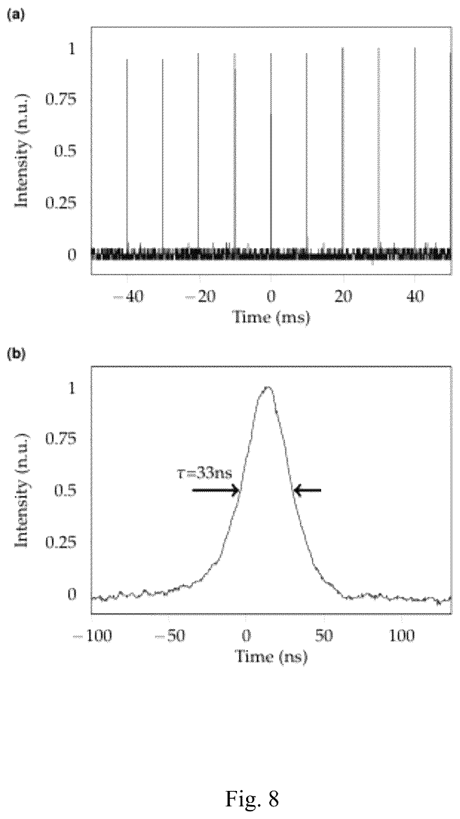

Reference is now made to FIG. 8, which illustrates the temporal parameters of the PQSL. FIG. 8a presents the temporal pulse train at a repetition rate of 50 Hz, and FIG. 8b depicts the temporal profile of a 33 ns pulse of the same system. The disclosed PQSL configuration provides pulses with durations ranging from approximately 33 to 58 ns, wherein higher pulse energies correspond to shorter pulse durations.

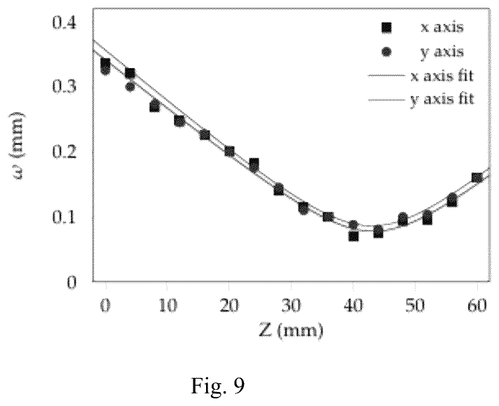

Reference is now made to FIG. 9, which demonstrates the PQSL beam quality. The beam quality was measured using a beam profiler, and the beam quality factor was calculated to be M²<1.1. The beam quality is described by the parameter M² proportional to the waist radios multiplied by the divergence angle ω(z) in bean radius at position z.

### Example 2

As a second non-limiting example, a passively Q-switched Tm:YLF solid-state laser 3000, configured as illustrated in FIG. 3, was operated at an output wavelength of 1907 nm, utilizing Ho:YAG as a saturable absorber. Ho-doped crystals may serve as saturable absorbers for thulium lasers, demonstrating their potential for high-energy pulse production in the 2 μm range.

The laser was configured between an entrance mirror (120) and an output coupler (160) [in one non-limiting example: radius of curvature (ROC) of approximately −200 mm and partial reflectance (PR) of approximately 55% at the selected emission wavelength], defining a total optical path length of approximately 175 mm. The gain medium (130) comprised a 3×3×20 mm³ Tm:YLF crystal with a thulium doping concentration of approximately 2 at. %, optionally temperature-stabilized (e.g., water-cooled) to approximately 20 °C. A 3×3×5 mm³ Ho:YAG crystal with a holmium doping concentration of approximately 0.3 at. % served as the SA (140), positioned adjacent to the gain medium (e.g., with a separation of approximately 0.1-1 mm, or otherwise in optical contact) to minimize the mode-area ratio and facilitate rapid saturation. One or more Brewster windows (240) were optionally inserted into the resonator to enforce polarization selection (in one non-limiting example, corresponding to σ-polarized emission in Tm:YLF at approximately 1907 nm). A series of three YAG etalons (150), optionally uncoated and arranged in the order of approximately 50 μm, 100 μm, and 25 μm, was placed in the optical path for spectral narrowing and wavelength control. The system was end-pumped by a 793 nm laser diode (110) operating at approximately 22.5 W, focused (210) to a spot of approximately 300 μm within the gain medium using pump optics, and pump-modulated to provide discrete pump bursts (e.g., in a range of approximately 10-200 Hz) configured to yield a single Q-switched pulse per pump burst.

In this configuration, pulse energies in the range of approximately 2.9 mJ to 4.2 mJ were obtained (in one non-limiting example, a maximum of approximately 4.2 mJ at 25 Hz), with nanosecond-scale pulse durations (e.g., approximately 50 ns) and peak powers on the order of 90 kW. Optical-to-optical efficiency was measured to be in the range of approximately 8% to 11.5% under optimized pump-modulation conditions. Without limitation to any particular theory, the improved performance at 1907 nm is attributed, at least in part, to stronger and/or broader Ho:YAG absorption at this wavelength relative to other absorption peaks, thereby reducing sensitivity to wavelength drift and facilitating more rapid saturation of the SA.

In further embodiments, wavelength stabilization at approximately 1907 nm may be achieved by configuring the output coupler (160) to comprise a volume Bragg grating (VBG) having a narrowband reflectance peak centered at or near an absorption peak of the SA at approximately 1907 nm, thereby reducing the number of intra-cavity wavelength-control elements relative to multi-etalon implementations, while enhancing emission wavelength stability.

While the invention has been described with reference to several preferred embodiments, it will be understood that various modifications, permutations, and equivalents may be made without departing from the scope of the invention. Accordingly, it is intended that the appended claims be interpreted as encompassing all such modifications, permutations, and equivalents as fall within the true spirit and scope of the present invention.

### REFERENCES

All citations referenced herein are hereby incorporated by reference in their entirety.
[1] Yang, K., Yang, Y., He, J. and Zhao, S., 2019. Q-switched 2 μm solid-state lasers and their applications. In Nonlinear Optics-From Solitons to Similaritons (pp. 1-16). London: IntechOpen.
[2] Scholle, K., Lamrini, S., Koopmann, P. and Fuhrberg, P., 2010. 2 μm laser sources and their possible applications. In Frontiers in guided wave optics and optoelectronics. IntechOpen.
[3] J. Yuan, B. Yao, T. Dai, Y. Gao, J. Yu, and J. Sun, Laser Phys. 30, 035004(2020 )
[4] B. Yao, J. Yuan, J. Li, T. Dai, X. Duan, Y. Shen, Z. Cui, and Y. Pan, Opt. Lett. 40, 348 (2015).
[5] R. Lan, P. Loiko, X. Mateos, Y. Wang, J. Li, Y. Pan, S. Choi, M. Kim, F. Rotermund, A. Yasukevich, K. Yumashev, U. Griebner, and V. Petrov, Appl. Opt. 55, 4877(2016 ).
[6] Kuo, Y. K., Birnbaum, M. and Chen, W., Ho:YLiF₄ saturable absorber Q-switch for the 2 μm Tm, Cr: Y₃Al₅O₁₂ laser. 1994 Applied physics letters, 65(24), pp.3060-3062.
[7] Wang, H., Huang, H., Wang, S. and Shen, D., 2018. Nanosecond Tm: Y2O3 ceramic laser passively Q-switched by a Ho: LuAG ceramic. Optical Engineering, 57(2), pp.026109-026109.
[8] Suliman, N., Shalman, I., Nahear, R., and Noach, S., “Passively Q-switched Tm:YLF laser based on Ho:YAG crystal as a saturable absorber,” Optics Letters 50(12), 3915-3918 (2025).
[9] Suliman, N., Shalman, I., Nahear, R., and Noach, S., “High-energy Tm:YLF laser passively Q-switched utilizing Ho:YAG crystal,” Proc. SPIE 13873-3, SPIE Photonics West (2026).
[10] Noach, S. (presenter), “High-energy Tm:YLF laser passively Q-switched utilizing Ho:YAG crystal,” SPIE Photonics West, LASE-13873-3 (18 Jan. 2026).

1. A passively Q-switched laser system, comprising: an entrance mirror (120);
an output coupler (160);
a gain medium (130) disposed between said entrance mirror and said output coupler;
a saturable absorber (SA) (140), characterized by an absorption spectrum comprising at least one absorption peak at an emission wavelength of said gain medium, positioned such that light emitted by said gain medium impinges upon said SA; and
an optical pump (110) configured to emit light corresponding to at least one absorption spectral line of said gain medium, and focusable (210) to illuminate said gain medium;
wherein said system further comprises at least one wavelength stabilizing element (WSE) (150) configured to restrict light within the cavity to a wavelength of approximately 10 nm full width at 90% maximum (FW(90%)M).

2. The system according to claim 1, wherein at least one of the following is held true:
a. said WSE is selected from the group consisting of a Volume Bragg Grating (VBG), an etalon, a combination of at least one VBG and at least one etalon, and a spectral filter;
b. said output coupler comprises a VBG;
c. said output coupler of section (b) is characterized by a reflectance of 60% at said absorption peak of said SA;
d. said WSE comprises a 5 mm intra-cavity etalon;
e. said WSE comprises a series of three etalons, each having a thickness in the range of 10 to 100 μm;
f. said gain medium comprises a thulium-doped (Tm-doped) crystal;
g. said gain medium of section (f) comprises Tm:YLF;
h said SA comprises a holmium-doped (Ho-doped) crystal;
k. said SA comprises Ho:YA;
l. said gain medium is Tm:YLF and said SA is Ho:YAG; and
m. a passively Q-switched laser (PQSL) is configured to emit light at a wavelength selected from the group consisting of 1880±2 nm and 1907±2 nm.

3. The system according to claim 1, wherein said optical pump is modulated to cease pumping after a pulse of said gain medium, and to resume only after partial depletion of an upper energy state of the SA.

4. The system according to claim 3, wherein said optical pump modulation is in the range of 10 to 500 Hz.

5. The system according to claim 1, wherein said system is configured to produce a pulse duration in the range of 33 to 58 ns.

6. The system according to claim 1, wherein said laser optical path is configured to be folded by a folding mirror (250).

7. The system of claim 16, wherein angle of incidence of folding mirror is 15°.

8. A method for generating laser light pulses in a passively Q-switched laser (PQSL), the method comprising the steps of:
providing a laser comprising an entrance mirror and an output coupler, together defining an optical path;
introducing a focusable optical pump external to the entrance mirror and aligned with the optical path of the laser;
positioning an SA within said laser optical path, said SA being characterized by an absorption spectrum comprising at least one absorption peak at an emission wavelength of said gain medium; and
inserting into said laser's optical path a WSE configured to transmit light at a wavelength of approximately 10 nm FW(90%)M of an absorption peak of said SA, said wavelength corresponding to that emitted by said gain medium.

9. The method according to claim 8, further comprising the step of introducing at least one additional WSE into said laser optical path to suppress secondary emissions.

10. The method according to claim 8, wherein said WSE is selected from the group consisting of at least one VBG, at least one etalon, or a combination of at least one VBG and at least one etalon.

11. The method according to claim 10, further comprising the step of providing said output coupler with a VBG.

12. The method according to claim 11, further comprising the step of configuring said output coupler to have a reflectance of 60% at said absorption peak of said SA.

13. The method according to claim 10, further comprising the step of providing said WSE with a 5 mm intra-cavity etalon.

14. The method according to claim 10, further comprising the step of providing said WSE with a series of three etalons, at least one having a thickness in the range of 10 to 100 μm.

15. The method according to claim 8, further comprising the step of providing said gain medium with a Tm-doped crystal.

16. The method according to claim 9, further comprising the step of providing said SA with a Ho-doped crystal.

17. The method according to claim 9, further comprising the steps of providing said gain medium with Tm:YLF, and providing said SA with Ho:YAG.

18. The method according to claim 17, further comprising the step of configuring said system to emit light at a wavelength selected from the group consisting of 1880±2 nm and 1907±2 nm.

19. The method according to claim 18, wherein at least one of the following is held true:
a. said method further comprising the step of modulating said optical pump to cease pumping after a pulse of said gain medium and to resume only after depletion of an upper energy state of the SA; and
a. said method further comprising the step of modulating said optical pump at a frequency in the range of 10 to 500 Hz.

20. The method according to claim 18, wherein at least one of the following is held true:
a. said method further comprising the step of configuring said system to produce a pulse duration in the range of 33 to 58 ns;
b. said method further further comprising the step of configuring said laser optical path to be folded by a folding mirror;
c. said method further comprising step of providing said incidence of folding mirror to 15°;
d. said method further further comprising the step of providing said gain medium with Tm:YLF; and
e. said method further further comprising the step of providing said SA with Ho:YAG.
